(19) United States
(12) Patent Application Publication
(10) Pub. No.: US 2006/0167956 A1
(43) Pub. Date: Jul. 27, 2006

(54) Media content transfer method and apparatus (aka shadow cache)

(75) Inventors: Jeffrey M. Chasen, Redmond, WA (US); Jeff Ray Watts, Seattle, WA (US)

Correspondence Address: STEVEN C. STEWART;REALNETWORKS, INC., 2601 ELLIOTT AVENUE, SUITE 1000, SEATTLE, WA, 98121, US

(73) Assignee: RealNetworks, Inc.

(21) Appl. No.: 11/045,424

(22) Filed: Jan. 27, 2005

(51) Int. Cl. G06F 17/30

(52) U.S. Cl. 707/203

(57) ABSTRACT

Additional version or versions of a media content is pre-generated on a first client device, after downloading the media content onto the first client device, but prior to the first client device receiving a request to provide the media content to a second client device.

### FIELD OF THE INVENTION

The present invention relates generally to the fields of data processing and digital media transfer.

### BACKGROUND OF THE INVENTION

Advances in microprocessor and related technologies have led to wide spread deployment and adoption of numerous general purpose as well as special purpose computing devices. General purpose computing devices, such as servers and desktop computers, are now endowed with computing power that was once reserved for the most expensive high end computers, requiring special conditioned environment to operate. Resultantly, many modern general purpose computing devices are multi-media, i.e. video, audio and graphics, enabled. Special purpose computing devices now include but are not limited to digital camcorders, digital versatile disk (DVD) players, personal digital assistants, wireless mobile phones, portable media players, and so forth.

Advances in networking, telecommunication, satellite, content serving and other related technologies have also led to increase in online multi-media content provision, including on demand and/or real time online delivery of video/or audio content, over private as and/or public networks, such as the Internet.

For certain media content, e.g. audio, increasingly a user may first access or consume the content via a primary client device, such as the user's desktop computer, and then later consume the content via a secondary client device, such as the user's portable media player. Very often, a user would first acquire the performance rights for the content, and download a version of the content onto the primary client device from a remote content provider, and then subsequently transfer a copy of the content onto the secondary client device from the primary client device.

Typically, the secondary client device is computationally less capable then the primary client device. As a result, the secondary client device often requires a version of the content that is less computationally intensive to render. In turn, content providers often have to offer multiple versions of the content, with some versions offering better quality/fidelity, but requiring more computational capabilities of the rendering devices, while other versions offer less quality/fidelity, but requiring less computational capabilities of the rendering devices.

Therefore, under the current state of the art, users who would like to enjoy contents on a variety of devices, often have to be cognizant of the differences in the version requirements of the different devices, and appropriately download and manage the various versions. The approach is network bandwidth inefficient, since multiple downloads are performed for the same media content, and user unfriendly, since the user has to manage the different versions.

Alternatively, some users elect to just work with, and enjoy the lowest common denominator of the users' devices, sacrificing quality/fidelity on the more computational capable devices. While this approach is more network bandwidth efficient, and user friendly in the sense that the user does not have to manage multiple versions, it offers the user a lesser experience when enjoying the content on the user's primary client device.

In other implementations, primary client devices are provided with transcoding capabilities, enabling a user to download and enjoy the higher quality/fidelity versions onto their primary client devices. Subsequently, when a user wants to transfer a copy of a downloaded content onto a secondary client device, the user would manually invoke the transcoding capability and instruct the transcoding function to generate a computational less intensive version (with lower quality/fidelity). While this approach is also more network bandwidth efficient, and more user friendly in that the user may enjoy higher quality/fidelity on his/her primary client device, it is still nonetheless user unfriendly in that it requires the user to be cognizant of, and manage the multiple versions.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of the invention, in accordance with various embodiments;

FIG. 2 illustrates a flow chart view of the download portion of the operational flow of the media manager of FIG. 1 in accordance with various embodiments;

FIG. 3 illustrates one aspect of a user interface to facilitate a user in requesting transfer of a media content from the primary client device to a secondary client device, in accordance with various embodiments;

FIG. 4 illustrates a flow chart view of the provision portion of the operational flow of the media manager of FIG. 1 in accordance with various embodiments;

FIG. 5 illustrates an example computing device suitable for practicing the invention, in accordance with various embodiments;

FIG. 6 illustrates an example storage device incorporated with an implementation of the media manager of FIG. 1, in accordance with various embodiments; and

FIG. 7 illustrates an example circuit board/ASIC incorporated with an implementation of the media manager of FIG. 1, in accordance with various embodiments.

### DETAILED DESCRIPTION OF ILLUSTRATIVE EMBODIMENTS

Illustrative embodiments of the present invention include but are not limited to methods for transferring media content from media content providers to client devices, and apparatuses adapted to practice these methods in part or in whole.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising”, “having”, and “including” are synonymous, unless the context dictates otherwise.

Client devices are designated as “primary” and “secondary” only for ease of understanding. While in general, primary client devices are typically more computationally capable than secondary client devices, however the present invention is not so limited. In various embodiments, the present invention may nonetheless be practiced with the secondary client devices having the same or greater computational capabilities. The difference in the version requirements may be caused by other factors, e.g. manufacturer preferences, that is the primary client device is manufactured by a manufacturer with one version preference, while the secondary client device is manufactured by another manufacturer with another version preference. In various implementations, the manufacturers may even be the same manufacturer.

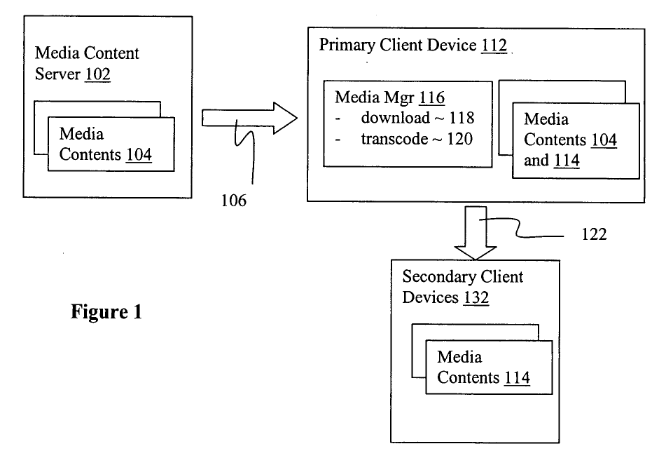

Referring now to FIG. 1, wherein an overview of the present invention, in accordance with various embodiments, is shown. As illustrated, primary client device 112 is endowed with media manager 116, which as will be explained in more detail below, is endowed with certain functions that enable the user to download 106 a media content 104 onto primary client device 112 from a media content server 102 only once, and yet be able to enjoy the media content 104 on the primary as well as the secondary client devices 112 and 132, at quality/fidelity levels that may be the highest the respective devices 112 and 132 can support.

The various embodiments are not only network bandwidth and user friendly in that a media content 104 is downloaded 106 once and may be consumed at the devices' maximum capabilities, the embodiments may also be user friendly in that the users are likely not required to be cognizant of the difference in version requirements of the two devices 112 and 132 (if there is a difference between their version requirements). In various embodiments, these differences may be differences in format, encoding and/or the manner digital right is managed.

Media content 104 represent a broad range of media content known in the art or to be designed (as long as they are consistent with the teachings of the present invention), including but are not limited to video, audio and/or graphic contents. Media content 104 may be packaged in any number of formats and/or encoding schemes known in the art or to be designed (as long as they are consistent with the teachings of the present invention). For example, the downloaded media content 104 may be encoded in the MPEG3 format, and the derivative version may be encoded in the MP3 format. Similarly, the digital rights of media content 104 may be managed in any number of manners known in the art or to be designed (as long as they are consistent with the teachings of the present invention). [MPEG=Moving Picture Experts Group.]

Continuing to refer to FIG. 1, in various embodiments, media manager 116 is endowed with a download function 118 that is adapted to negotiate with media content server 102 to download 106 a version of a content 104 that exploits the computational capabilities of primary client device 112 as much as possible. Additionally, media manager 116 is endowed with transcoding capabilities 120 that are proactively invoked by media manager 116 to generate additional versions 114 of a downloaded media content 104, prior to media manager 116 receiving a request (e.g. from the user) to transfer 124 a copy of the media content 114 to secondary client device 132. Further, media manager 116 is endowed with transfer function 122 to transfer an appropriate version of a selected media content 114 onto secondary client device 132 from primary client device 112.

In various embodiments, primary client device 112 is coupled with media content server 102 via one or more wired or wireless networks, which may be private and/or public networks, including but not limited to the Internet. Primary and secondary client devices 112 and 132 on the other hand, are coupled to each other via a parallel or a serial connection. In various embodiments, the serial connections may be a Universal Serial Bus (USB) connection or a IEEE 1394 Serial Bus connection (IEEE=Institute of Electrical and Electronic Engineers). In alternate embodiments, primary and secondary client devices 112 and 132 may be coupled via a wired or wireless local area network connection instead.

Except for media manager 116, media content server 102, primary client device 112 and secondary client device 132 represent a broad range of these devices known in the art or to be designed, consistent with the teachings of the present invention. Examples of media content servers 102 include but are not limited to servers available from companies such as Hewlett Packard of Palo Alto, Calif., and Sun Microsystems of Menlo Park, Calif. The media content servers 102 may e.g. be operated by media content providers, such as RealNetworks of Seattle, Wash. In various embodiments, primary client devices 112 may be a set-top box available e.g. from Samsung Corporation of Seoul, Korea or a desktop computer available from Dell Computer of Austin, Tex. In various embodiments, secondary client devices 112 may be a portable media player available from e.g. Apple Computer of Cupertino, Calif.

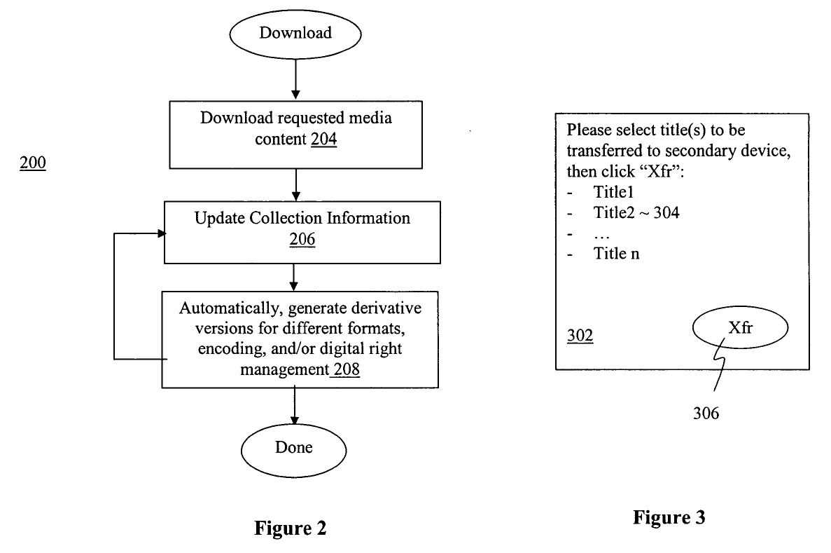

FIG. 2 illustrates a flow chart view of a portion of the operational flow of download function 118 of media manager 116, in accordance with various embodiments. As illustrated, in response to a request to download a media content 104 from a media content server 102, media manager 116 downloads the requested media content 104 onto primary client device 112 from media content server 102 accordingly, block 206.

In various embodiments, media manager 116 effectuates the download over an established network connection between primary client device 112 and media content server 102, using communication services available on primary client device 112. In various embodiments, the network connection may be a HTTP connection (HTTP=Hypertext Transmission Protocol).

In various embodiments, media manager 116 is endowed with the capabilities to discover the various versions available from media content server 102, and request for the highest version (in terms of quality/fidelity) primary client device 112 is capable of supporting. In various embodiments, media manager 116 may be adapted to prompt and be provided with such information, i.e. the highest version (in terms of quality/fidelity) primary client device 112 is capable of supporting, during installation. In other embodiments, media manager 116 may be adapted to allow such information be configurable by e.g. a user, post installation. In still other embodiments, media manager 116 may be endowed with the capability to determine the capability of primary client device 112 by discovering the capabilities of the various components of primary client device 112, such as the computing power of its processor, the data transfer capability of its internal data transfer channels, the amount of volatile and persistent storage available and so forth. Generally, higher quality/fidelity of media content may be supported with correspondingly higher computing power, faster data transfer capability, and/or larger amount of volatile/persistent storage available. The relationships may e.g. be empirically determined and pre-provided to media manager 116.

Continuing with FIG. 2, for the embodiments, media manager 116 is adapted to maintain a directory of the downloaded collection of media content 104. Accordingly, for the embodiments, media manager 116 updates the directory of its downloaded collection accordingly, block 206.

As described earlier, in various embodiment's, media manager 116 is further adapted to proactively generate a number of derivative versions 114 of a downloaded media content 104, prior to receiving a request (e.g. from a user) to transfer a copy of the downloaded media content 104 to secondary client device 132, block 208.

In various embodiments, media manager 116 is adapted to generate a predetermined number of derivative versions 114 that differ from each other in formats, encoding and/or the manner digital rights are managed. In various embodiments, the derivative versions 114 are the likely versions required by secondary client device 132. The derivative versions 114 may be the versions required by the most popular portable media players, without taking into consideration the device type of primary client device 112. In other embodiments, the device type of primary client device 112 may be taken into consideration to infer the likely device type of secondary client device 132, e.g. primary client device 112 has a proprietary architecture requiring a particular type of secondary client device 132.

In various embodiments, a user may be offered the option of customizing the proactive generation by specifying the derivative versions to be proactively generated, or specifying one or more device types for the secondary client devices (based on which, the media manager 116 determines the derivative version to be proactively generated).

As illustrated in FIG. 2, for the embodiments, media manager 116 is further adapted to update its collection information, each time an additional derivative version 114 is generated. In various embodiments, media manager 116 immediately generates the derivative versions as part of the download process. In other embodiments, media manager 116 schedules the transcoding/generation as background tasks, as soon as a media content 104 is downloaded. In various embodiments where priority may be assigned to background task, media manager 116 may further assign equal or descending priorities to the background tasks.

In various embodiments, to facilitate ease of subsequent retrieval, the downloaded versions and the proactively generated derivative versions of the media content files are stored together in a common repository or folder (also referred to as a cache). In various embodiments, a globally unique identifier (GUID) is generated and assigned to each version of each media content file. In various embodiments, the GUIDs of the derivative versions are generated, based at least in part on the GUID of the download version, employing a deterministic algorithm. The deterministic algorithm may be any one of a number of hashing schemes.

In various embodiments, the user may be offered a facility to selectively delete the proactively generated derivative versions of a media content file. In various embodiments, the proactively generated derivative versions of a media content file may also be deleted, when the downloaded version of the media content file is deleted by the user.

FIG. 3 illustrates a portion of an end user interface, media manager 116 employs to facilitate a user of primary client device 112 to request transfer of a media content 104 to secondary client device 132, in accordance with some embodiments. As illustrated, for the embodiments, notwithstanding the fact that media manager 116 have in possession of multiple versions 114 of media contents 104, media manager 116 presents each title for selection in a selection list 302 by a user only once. That is, for these embodiments, the user is shielded from having to be cognizant of the various available versions 114 of the downloaded media contents 104. The collection of the various versions 114 operates like a cache in the shadow, hidden from the user.

In various embodiments, select list 302 may simply be an ascending or descending listing of all titles of media contents 104, downloaded onto primary client device 112. In other embodiments, select list 302 may be a selected subset of media contents 104 downloaded onto primary client device 112, based on any one of a number of selection criteria, such as media content types (video, audio and so forth), music types (rock n roll, country western and so forth), video types (drama, comedy and so forth). In various embodiments, the selection criteria may be provided by the user. In still other embodiments, select list 302 may exclude titles previously transferred onto secondary client device 132.

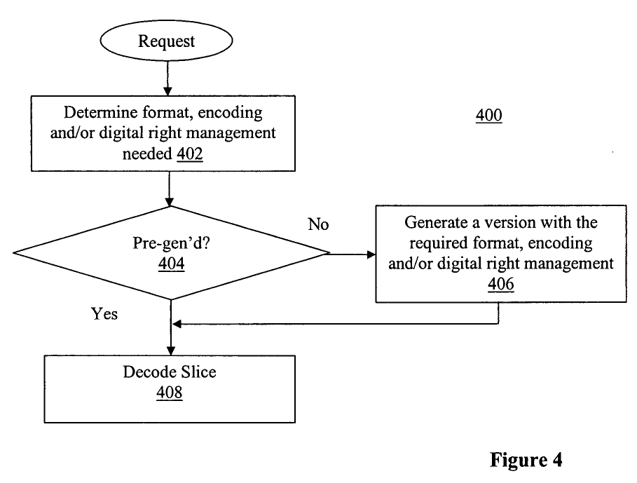

FIG. 4 illustrates a flow chart view of a portion of the operational flow of transfer function 122 of media manager 116, in accordance with various embodiments. As illustrated, in response to the receipt of a request to transfer a media content 104 from primary client device 112 to secondary client device 132, transfer function 122 determines the appropriate version 114 to be transferred, block 402. In various embodiments, the appropriate version 114 is the version having the appropriate format, encoding and/or digital right management.

In various embodiments, transfer function 122 infers the appropriate version 114 based on the device type of secondary client device 132. In other embodiments, transfer function 122 determines the appropriate version 114, by requesting the information from secondary client device 132.

While the present invention is being described with the above embodiments where media manager 116 is endowed with the capabilities to free the user from having to be cognizant of the version requirement of secondary client device 132, nonetheless, a portion of the benefits of the present invention may still be realized (e.g. operational efficiency), even if the present invention is practiced with the user specifying the device type of secondary client device 132 or even the appropriate version requirement of secondary client device 132.

Continuing to refer to FIG. 4, as illustrated, on determining the appropriate version 114 of the selected media content 104, transfer function 122 determines if the appropriate version 114 has been generated, block 404. If so, transfer function 122 proceeds to transfer the appropriate version 114 to secondary client device 132, block 408. Thus, in most embodiments, the user may experience improved transfer performance, as the required appropriate version 114 is readily available.

However, if appropriate version 114 has not been generated, for whatever reasons, e.g. the version was not among the predetermined versions to be proactively pre-generated, or the transfer request came in before the proactive pre-generation is completed, transfer function 122 invokes transcode function 120 to generate (or complete generating) the required version 114, block 406, before proceeding to transfer the appropriate version 114 to secondary client device 132, block 408. In various embodiments, the on-demand generated versions are added to the other proactively pre-generated versions, and made available for subsequent re-selection and additional transfer to the same or other secondary client devices.

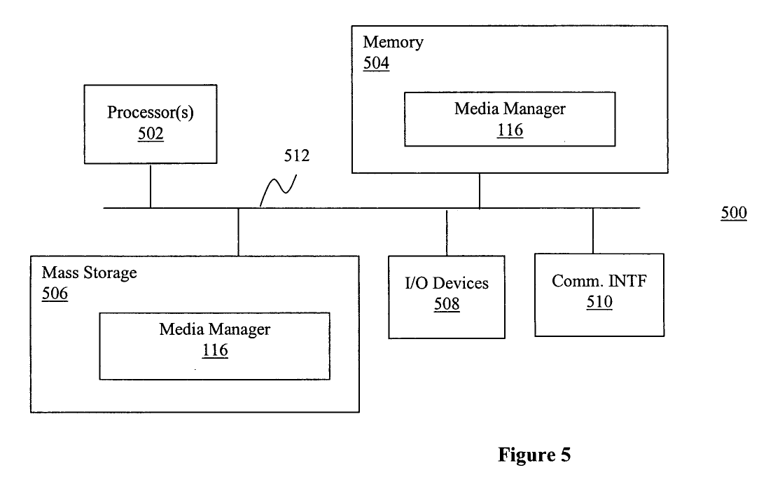

FIG. 5 illustrates a block diagram view of an example computing device suitable for use as primary client device 112 to practice the present invention, in accordance with one embodiment. As illustrated, computing device 500 includes processor 502, memory 504 coupled to each other via bus 512. Further, computing device 500 also includes mass storage device 506. I/O devices 508, and communication interface 510 coupled to the earlier described elements as shown.

Each of the elements represents a broad range of the corresponding element known in the art or to be designed consistent with the teachings of the present invention. They perform their conventional functions, i.e. processing, storage, and so forth. In particular, memory 504 and mass storage 506 are employed to store temporal and persistent copies of media manager 116 respectively.

In various embodiments, communication interface 510 includes a networking interface as well as a serial interface, and computing device 500 is desktop computer, set-top box, or an entertainment control unit.

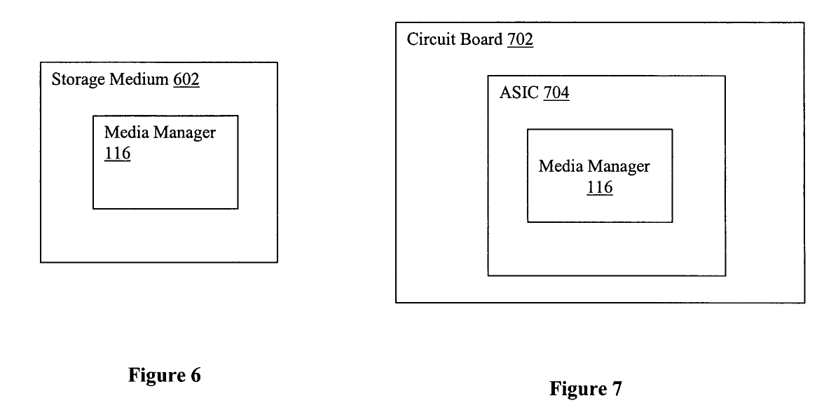

FIG. 6 illustrates an example storage medium 602 endowed with media manager 116, in accordance with some embodiments. In various embodiments, the endowed media manager 116 is a software implementation, and it may be used to program a computing device to practice the earlier described methods, or aspects thereof.

FIG. 7 on the other hand illustrates an example hardware implementation, where circuit board 702 is endowed with an ASIC 704 having media manager 116. In various embodiments, circuit board 702 may be incorporated into various systems, to enable the systems to practice the earlier described methods, or aspects thereof. [ASIC=Application Specific Integrated Circuit.]

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

What is claimed is:

1. A method comprising:
downloading a first version of a media content onto a first client device from a media content server; and
the first client device automatically pre-generating a second version of the media content on the first client device, prior to the first client device receiving a request to provide a second client device with the media content, the first and second versions being different in at least one aspect selected from the group consisting of a format aspect, an encoding aspect, and a digital right management aspect.

2. The method of claim 1, wherein the first and second versions have different formats.

3. The method of claim 1, wherein the media content of the first and second versions are encoded differently.

4. The method of claim 1, wherein the digital rights of the media content of the first and second versions are managed differently.

5. The method of claim 1, wherein the first version is a MPEGn version, and the second version is a MP3 version.

6. The method of claim 1, wherein the method further comprises generating an identifier for the second version of the media content, based at least in part on an identifier of the first version of the media content.

7. The method of claim 1, wherein the method further comprises receiving an indication to delete the first version of the media content, and deleting, in response, the first and the second version of the media content.

8. The method of claim 1, further comprising the first client device automatically pre-generating a third version of the media content on the first client device, prior to the first client device receiving a request to provide a second client device with the media content, the first, second and third versions being different from each other in at least one aspect selected from the group consisting of a format aspect, an encoding aspect, and a digital right management aspect.

9. The method of claim 1, further comprising the first client device determining an appropriate version of the media content to be provided from the first client device to the second client device.

10. The method of claim 9, wherein said determining comprises the first client device receiving (a) a specification of the appropriate version from a selected one of a user and the second client device, or (b) a specification of a device type for the second client device from a selected one of a user and the second client device, and inferring the appropriate version from the received specification.

11. The method of claim 9, wherein the method further comprises dynamically generating the appropriate version of the media content in real time, when no pre-generated versions, including the first and second versions, is determined to be the appropriate version.

12. An article of manufacture comprising
a storage medium; and
a plurality of instructions stored in the storage medium, adapted to enable an apparatus programmed with the instructions to practice the method of claim 1.

13. The article of claim 12, wherein the first and second versions have different formats.

14. The article of claim 12, wherein the media content of the first and second versions are encoded differently.

15. The article of claim 12, wherein the digital rights of the media content of the first and second versions are managed differently.

16. A system comprising
a storage medium having stored therein a plurality of instructions stored in the storage medium, adapted to enable the system to practice the method of claim 1; and
a processor coupled to the storage medium to execute the instructions.

17. The system of claim 16, wherein the first and second versions have different formats.

18. The system of claim 16, wherein the media content of the first and second versions are encoded differently.

19. The system of claim 16, wherein the digital rights of the media content of the first and second versions are managed differently.

20. The system of claim 16, wherein the system comprise a selected one from the group consisting of a set-top box, an entertainment control unit, a desktop computer and a laptop computer.

21. A method comprising:
receiving by a first client device, a request to transfer a copy of a media content to a second client device;
determining by the first client device, an appropriate one among a plurality of pro-actively pre-generated versions of the media content to transfer to the second client device, the proactively pre-generated versions of the media content being different in at least one aspect selected from the group consisting of a format aspect, an encoding aspect, and a digital right management aspect; and
transferring the determined appropriate one of the pro-actively pre-generated versions of the media content to the second client device.

22. The method of claim 21, wherein a first and a second of the plurality versions have different formats.

23. The method of claim 21, wherein the media content of a first and a second of the plurality of versions are encoded differently.

24. The method of claim 21, wherein the digital rights of the media content of a first and a second of the plurality of versions are managed differently.

25. The method of claim 21, wherein said determining comprises the first client device receiving (a) a specification of an appropriate version from a selected one of a user and the second client device, or (b) a specification of a device type for the second client device from a selected one of a user and the second client device, and inferring the appropriate version from the received specification.

26. The method of claim 21, wherein the method further comprises dynamically generating an appropriate version of the media content in real time, if none of the pro-actively pre-generated versions is determined to be the appropriate one, and said transmitting comprises transmitting the dynamically generated version instead.

27. An article of manufacture comprising
a storage medium; and
a plurality of instructions stored in the storage medium, adapted to enable an apparatus programmed with the instructions to practice the method of claim 21.

28. A system comprising
a storage medium having stored therein a plurality of instructions stored in the storage medium, adapted to enable the system to practice the method of claim 21; and
at least one processor coupled to the storage medium to execute the instructions.

29. The system of claim 28, wherein the system comprise a selected one from the group consisting of a set-top box, an entertainment control unit, a desktop computer and a laptop computer.
